(19) United States
(12) Patent Application Publication
(10) Pub. No.: US 2005/0206757 A1
(43) Pub. Date: Sep. 22, 2005

(54) Image pickup device and image pickup apparatus

(75) Inventor: Hiroshi Itoh, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Optical Company, LTD., Tokyo (JP)

(21) Appl. No.: 11/074,471

(22) Filed: Mar. 8, 2005

(30) Foreign Application Priority Data
Mar. 19, 2004 (JP) 2004-081653

(51) Int. Cl. H04N 3/14

(52) U.S. Cl. 348/294

(57) ABSTRACT

This invention provides an image pickup device including: a pixel portion including pixels Pxl arranged in a two-dimensional array for generating and storing photoelectric conversion signals in accordance with an amount of light exposure; a first reading portion for reading photoelectric conversion signals of the pixels Pxl at a first cycle; a first selection portion for selecting the pixels Pxl read by the first reading portion as all the pixels arranged in the pixel portion; a second reading portion for reading the photoelectric conversion signals of the pixels Pxl at a second cycle; and a second selection portion for selecting the pixels Pxl to be read by the second reading portion as a part of all the pixels arranged in the pixel portion and setting a plurality of the second cycles to be included in the first cycle.

This application claims benefit of Japanese Application No. 2004-081653 filed in Japan on Mar. 19, 2004, the contents of which are incorporated by this reference.

### BACKGROUND OF THE INVENTION

1. Field of the Invention

The present invention relates to an image pickup device including a plurality of pixels arranged in a two-dimensional array, and to an image pickup apparatus using the image pickup device.

2. Description of the Related Art

In an image pickup device including a plurality of pixels arranged in a two-dimensional array, various techniques for reading photoelectric conversion signals from the pixels a plurality of times for each predetermined cycle have been proposed.

One of these techniques is, for example, disclosed in Japanese Unexamined Patent Application Publication No. 10-93868. The technique disclosed in Japanese Unexamined Patent Application Publication No. 10-93868 is for reducing noises overlaid on photoelectric conversion signals. That is to say, a plurality of pixels provided for an image pickup device have minute sizes, and thus it is difficult to keep all the pixels to have the same performance and the same size. Accordingly, it is inevitable for each pixel to have an individual difference. In particular, it is known that a noise component occurring in each pixel has an individual difference. Known techniques for reducing such a noise component overlaid on a photoelectric conversion signal from a pixel include the following as an example. First, a photoelectric conversion signal obtained from each pixel by receiving light for a predetermined period and having been stored is read. Next, the reset of each pixel immediately after reading the photoelectric conversion signal is performed to flush the stored electric charge. A signal component immediately after the reset is read from each pixel. By subtracting the latter signal from the former signal, an individual noise is reduced for each pixel. Using such a technique, it becomes possible to offset noises overlaid on both of the photoelectric conversion signal with a storage time of 0 [sec] (namely, immediately after the reset) and the photoelectric conversion signal obtained by receiving light for a predetermined period and storing it. However, by such a technique, it is not possible to reduce noises dependent on the amount of light, which becomes noticeable when the target object has a low luminance. To cope with this, the technique disclosed in Japanese Unexamined Patent Application Publication No. 10-93868 described above makes it possible to reduce noises dependent on the amount of light. Specifically, in the technique disclosed in Japanese Unexamined Patent Application Publication No. 10-93868, first reading is performed on the photoelectric conversion signal obtained by receiving light for a first predetermined period and storing it, and after completing the first reading, electric charge is stored by receiving light for a second predetermined period subsequently without resetting the stored electric charge. After the second predetermined period has completed, the second reading of the photoelectric conversion signal obtained by the storage is performed. After the second reading is completed, the reset operation is performed. The electric charge of the pixel is read by repeating such a series of operations. Next, the difference between the photoelectric conversion signal obtained by the first reading and the photoelectric conversion signal obtained by the second reading is obtained. Thus, a noise component overlaid on each signal, particularly, a noise component dependent on the amount of light when the target object has a low luminance is offset or reduced. Furthermore, according to the technique disclosed by Japanese Unexamined Patent Application Publication No. 10-93868, it becomes possible to expand the dynamic range by adding a plurality of photoelectric conversion signals obtained by reading a plurality of times at a predetermined cycle.

Incidentally, in order to pick up moving images, the signals of all the pixels in an image pickup apparatus must be read in a predetermined time period (a read-time period of one frame which makes up moving images). However, the time required for reading pixels becomes longer as the number of pixels increases. Thus, it becomes difficult to use an image pickup device having a large number of pixels for shooting moving images without change unless something is devised. In order to cope with this, in a known technique, a pixel portion of an image pickup device is divided into a plurality of areas, and a plurality of reading means for reading photoelectric conversion signals from the pixels is provided so as to correspond to each divided area, and the plurality of reading means simultaneously performs the read operation by sharing. Use of such a technique makes it possible to read a large number of pixel signals in a short time.

However, in such a technique, since there are a plurality of reading means, if individual reading means have differences in circuit characteristics, the differences cause the variations of the photoelectric conversion signal characteristics. Thus, fixed-pattern noise occurs for each divided area, thereby causing the deterioration of the image quality.

Accordingly, Japanese Unexamined Patent Application Publication No. 2000-209503 discloses a technique in which overlapping pixel portions are provided in the boundary portions of the divided areas when the pixel portion is divided, and the signal of the overlapped pixel portion can be individually read by a plurality of reading means. For the overlapped portions, the average signal of the photoelectric conversion signals read from the plurality of reading means is adopted, and thus the image deterioration occurring in the boundary portions of the areas is reduced.

Meanwhile, for image pickup devices, there are two types. One is a type of devices in which the charge stored in each pixel is flushed every time they are read (in the following, referred to as a destructive-read type). The other is a type of devices in which the charge is not flushed no matter how may times they are read unless the reset is performed (in the following, referred to as a nondestructive-read type). Among these, the former type, namely, a destructive-read type of image pickup devices are employed in various equipment in recent years, and has become the mainstream of the devices.

For example, a CCD-type image pickup device is a destructive-read type in which a charge generated by photoelectric conversion is directly read as a video signal so that the charge cannot be read twice when having been read once. Also, in a CMOS-type image pickup device, destructive-read operations are performed in order to reduce special noise called kTC noise, and thus this device is also a destructive-read type in which the photoelectric conversion charge from the same pixel cannot be read again at a different timing.

Here, a description will be given of the general structure of a pixel of a CMOS-type image pickup device performing destructive-read, and the read operation thereof with reference to FIGS. 9 and 10 according to embodiments of the present invention.

In general, as shown in FIG. 9, a pixel of a CMOS-type image pickup device performing destructive-read includes a photodiode PD, and transistors Tr1, Tr2, Tr3, and Tr4. The photodiode PD performs photoelectric conversion, and stores a charge. The transistor Tr4 functions as a switch for connecting the charge stored in the photodiode PD to the gate of the transistor Tr2. The transistor Tr2 converts the charge transferred from the photodiode PD into a voltage. The transistor Tr1 resets the charge stored in the gate of the transistor Tr2. The transistor Tr3 functions as a switch for turning on/off on whether or not the current flowing between the source and the drain of the transistor Tr2 is connected to the pixel-signal read line Vn in accordance with the charge stored in the gate of the transistor Tr2.

The operation of such a pixel of the image pickup device is performed as shown in FIG. 10.

First, the charge of the gate of the transistor Tr2 is reset by the transistor Tr1. This operation flushes the charge stored so far, that is to say, so-called destruction is carried out.

By turning on the transistor Tr3 immediately after the reset, the signal of transistor Tr2 immediately after the reset is read on the pixel-signal read line Vn as a reset signal.

Thereafter, charge is stored for a predetermined time period by the photodiode PD. After a predetermined time has passed, by turning on the transistor Tr4, the photoelectric conversion signal stored in the photodiode PD is transferred to the gate of the transistor Tr2.

Subsequently, by turning on the transistor Tr3, the signal of the transistor Tr2 is read on the pixel-signal read line Vn as a photoelectric conversion signal of the pixel.

Since nearly the same kTC noise is overlaid on the reset signal and the photoelectric conversion signal, it is possible to obtain a signal with a reduced noise component by calculating the difference of these signals.

Also, in an image pickup apparatus for picking up an image of an object, automatic focusing (AF) and automatic exposure (AE) is carried out, and thus an object image formed on the image pickup device is brought into focus and the amount of exposure is adjusted to obtain an appropriate image signal. Such AF and AE operations are desirable to be performed in a short time. This is because appropriate video cannot be obtained unless the aperture control and the electronic shutter control based on AE and the focus control of the photographing optical system based on AF have been completed. Accordingly, if it takes time to perform AE and AF, for example, in the case of a digital camera for obtaining still images, the time lag between the pushing of the shutter button and the picking up of an image increases, thereby losing a shutter chance. In the case of a video camera for capturing moving images, it takes a long time to adjust brightness and focus, thereby inappropriate images are picked up for a long time.

The AF and AE functions described above may be performed by a dedicated device provided separately from the image pickup device. However, in order to have a simple configuration to save cost, the image signal captured by the image pickup device is sometimes used for analysis, etc., and the AF and AE functions are performed based on that result. In the latter case, in order to perform the AE and AF functions at a high speed, it is necessary to read photoelectric conversion signals to be used for the control of AE, AF, etc., in a short time as much as possible.

From the viewpoint as described above, a method in which, for example, of the photoelectric conversion signals read from pixels in a predetermined cycle for a plurality of times, the photoelectric conversion signal read latest is used for the actual video signal and the other photoelectric conversion signals are used for the control of automatic exposure (AE), automatic focusing (AF), etc., in the image pickup apparatus is considered.

However, in the image pickup device of the destructive-read type described above, a pixel charge is destroyed, and thus it is not possible to read a plurality of times in a predetermined cycle, namely, one frame cycle. Thus, for example, if a plurality of areas are set in a screen with partly overlapping, it is impossible to capture images of the sub-screens of the plurality of areas unless an additional frame buffer, etc., are provided.

Also, in the image pickup device disclosed in Japanese Unexamined Patent Application Publication No. 10-93868 described above, it is possible to read a photoelectric conversion signal output from a specific pixel two times in a predetermined cycle, namely, one cycle. Thus the image signal read first time is considered to be used for AE and AF. However, in the image pickup device disclosed in Japanese Unexamined Patent Application Publication No. 10-93868, the restriction that the first read timing and the second read timing are not simultaneous is added. Thus, the cycle of capturing the first signal and the cycle of capturing the second become the same. Accordingly, the cycle of capturing a normal video camera signal and the cycle of capturing the AE and AF signals become the same, thereby not meeting the purpose of performing high-speed AE and AF. Furthermore, unless an additional frame buffer, etc., are provided, it is not possible to capture only the photoelectric conversion signals of a desired portion area to use them for AE and AF.

Moreover, in the image pickup device disclosed in Japanese Unexamined Patent Application Publication No. 2000-209503, although it is possible to independently read the photoelectric conversion signals from specific pixels included in a boundary portions, through read lines each of which is connected to a plurality of reading means, respectively, the other pixels can be read only from one reading means, because each of the other pixels is connected only to the read line of any one reading means. Accordingly, the photoelectric conversion signals of an arbitrary area cannot be used for AE and AF. Furthermore, in Japanese Unexamined Patent Application Publication No. 2000-209503, a method of reading the boundary pixels a plurality of times in a predetermined cycle while reading a normal video signal has not been disclosed. In this regard, a solid-state image pickup device disclosed in Japanese Unexamined Patent Application Publication No. 2000-209503 is based on the assumption that the device is of nondestructive-read type as described in the paragraph number [0016] of the publication.

### SUMMARY OF THE INVENTION

Accordingly, it is an object of the present invention to provide an image pickup device and an image pickup apparatus capable of arbitrarily reading the photoelectric conversion signal of the pixel selected from all the pixel area a plurality of times at a predetermined cycle.

Also, another object of the present invention is to provide an image pickup device and an image pickup apparatus capable of outputting a plurality of sub-screens which are partly overlapped among all the pixel areas in real time without requiring additional frame memory, etc.

Briefly, according to an aspect of the present invention, there is provided an image pickup device including: a pixel portion including a plurality of pixels arranged in a two-dimensional array, the pixel portion generating and storing photoelectric conversion signals in accordance with an amount of light exposure; a plurality of reading means for allowing to read each of the photoelectric conversion signals stored in the pixels of the pixel portion at a predetermined cycle; and a plurality of selection means provided corresponding to the plurality of reading means with one-to-one relation for selecting a pixel to be read by the reading means from all the pixels arranged in the pixel portion, wherein at least one of the plurality of reading means reads a photoelectric conversion signal stored in the pixel selected by the corresponding selection means a plurality of times in the predetermined cycle.

Also, according to another aspect of the present invention, there is provided an image pickup device including: a pixel portion including a plurality of pixels arranged in a two-dimensional array for generating and storing photoelectric conversion signals in accordance with an amount of light exposure; a plurality of reading means for reading each of the photoelectric conversion signals stored in the pixels of the pixel portion; a plurality of selection means provided corresponding to the plurality of reading means with one-to-one relation for selecting a pixel to be read by the reading means from all the pixels arranged in the pixel portion; and memory means for individually storing the photoelectric conversion signal read from the pixel arranged in the pixel portion corresponding to each of the plurality of reading means.

Furthermore, according to another aspect of the present invention, there is provided an image pickup apparatus including: an image pickup device including a pixel portion including a plurality of pixels arranged in a two-dimensional array for generating and storing photoelectric conversion signals in accordance with an amount of light exposure, a plurality of reading means for allowing to read each of the photoelectric conversion signals stored in the pixels of the pixel portion at a predetermined cycle, and a plurality of selection means provided corresponding to the plurality of reading means with one-to-one relation for selecting a pixel to be read by the reading means from all the pixels arranged in the pixel portion, wherein at least one of the plurality of reading means reads a photoelectric conversion signal stored in the pixel selected by the corresponding selection means a plurality of times in the predetermined cycle; and control means for individually controlling a pair of the reading means and the selection means corresponding to the reading means included in the image pickup device.

Also, according to another aspect of the present invention, there is provided an image pickup apparatus including: an image pickup device including a pixel portion including a plurality of pixels arranged in a two-dimensional array for generating and storing photoelectric conversion signals in accordance with an amount of light exposure; a plurality of reading means for reading each of the photoelectric conversion signals stored in the pixels of the pixel portion, a plurality of selection means provided corresponding to the plurality of reading means with one-to-one relation for selecting a pixel to be read by the reading means from all the pixels arranged in the pixel portion, and memory means for individually storing the photoelectric conversion signal read from the pixel arranged in the pixel portion corresponding to each of the plurality of reading means; and control means for individually controlling a pair of the reading means and the selection means corresponding to the reading means included in the image pickup device.

The above and other objects, features and advantages of the invention will become more clearly understood from the following description referring to the accompanying drawings.

### BRIEF DESCRIPTION OF THE DRAWINGS

FIG. 1 is a block diagram illustrating a schematic configuration of an image pickup device according to a first embodiment of the present invention;

FIG. 2 is a diagram illustrating an example of an image pickup device including 4×4 pixels in the first embodiment;

FIG. 3 is a circuit diagram illustrating a specific example of the configuration of a pixel in the first embodiment;

FIG. 4 is a flowchart illustrating the operation of reading a signal from a pixel in the first embodiment;

FIG. 5 is a diagram illustrating the configuration of lines in the image pickup device in FIG. 2;

FIG. 6 is a diagram illustrating an example of a luminance distribution of an object to be the image pickup target in the first embodiment;

FIG. 7 is a timing chart illustrating the operation of the image pickup device when the image of the object shown in FIG. 6 is picked up;

FIG. 8 is a block diagram illustrating a schematic configuration of an image pickup device according to a second embodiment of the present invention;

FIG. 9 is a circuit diagram illustrating a specific example of the configuration of a pixel used in the image pickup device in the second embodiment;

FIG. 10 is a flowchart illustrating the operation of reading a signal from the pixel shown in FIG. 9;

FIG. 11 is a diagram illustrating an example of an image pickup device including 5×5 pixels in the second embodiment;

FIG. 12 is a timing chart illustrating the operation of the image pickup device when an image is picked up by the image pickup device shown in FIG. 11;

FIG. 13 is a diagram illustrating an example in which memory means includes a capacitor in the image pickup device shown in FIG. 8;

FIG. 14 is a block diagram illustrating an image pickup apparatus including an image pickup device according to a third embodiment of the present invention;

FIG. 15 is a block diagram illustrating the configuration of the image pickup apparatus for performing image-pickup control based on output signals from an image pickup device in the third embodiment; and

FIG. 16 is a block diagram illustrating an example of the configuration of the image pickup system in which monitors are connected to an image pickup device according to a fourth embodiment of the present invention.

### DETAILED DESCRIPTION OF PREFERRED EMBODIMENTS

In the following, a description will be given of embodiments of the present invention with reference to the drawings.

### First Embodiment

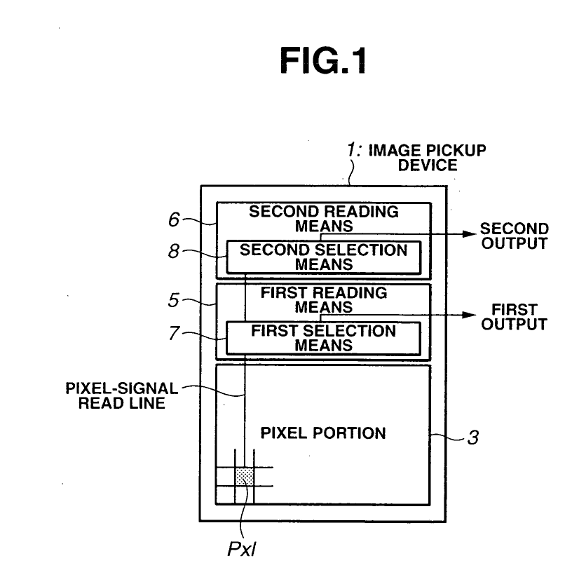

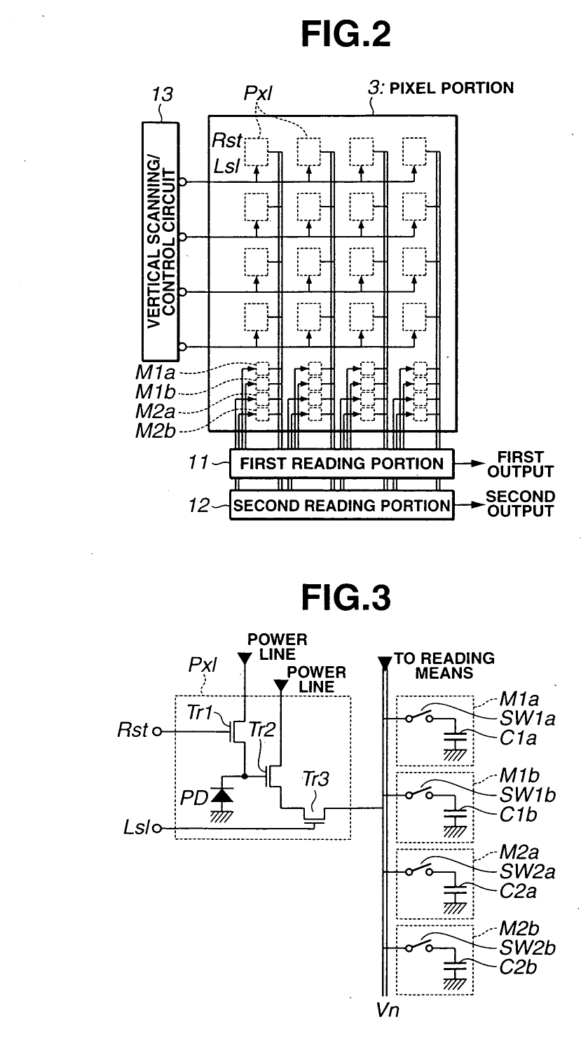

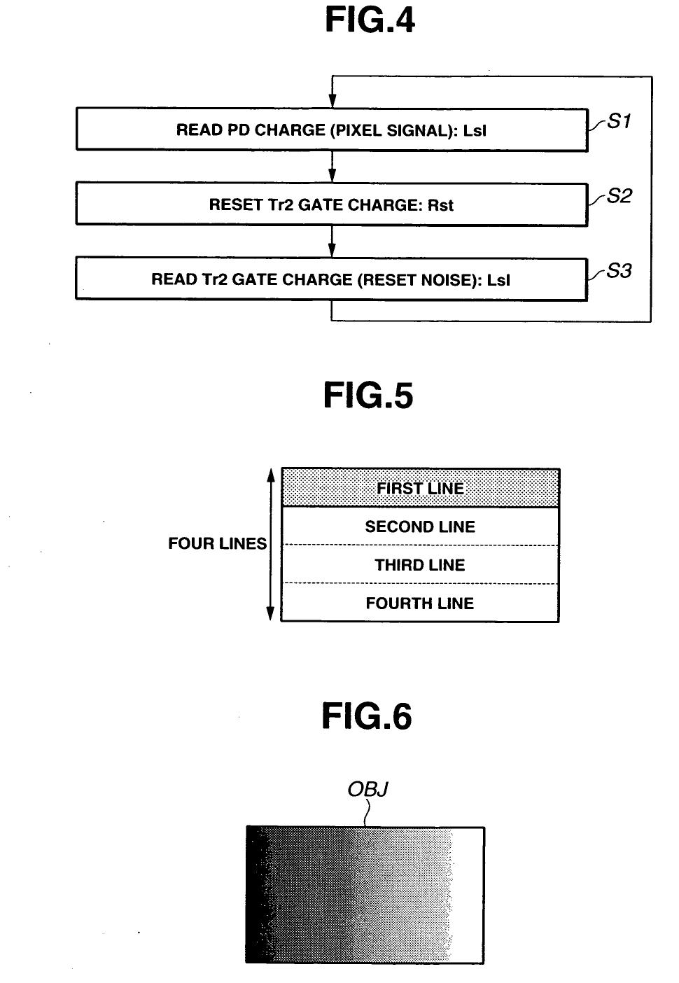

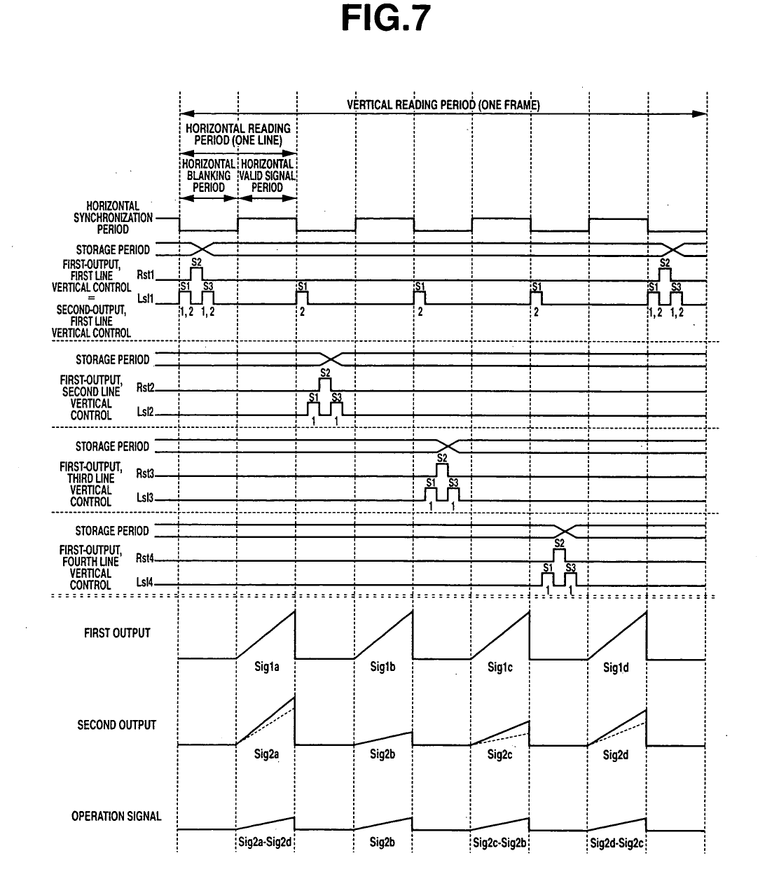

FIG. 1 to 7 illustrate a first embodiment of the present invention. FIG. 1 is a block diagram illustrating a schematic configuration of an image pickup device. FIG. 2 is a diagram illustrating an example of an image pickup device including 4×4 pixels. FIG. 3 is a circuit diagram illustrating a specific example of the configuration of a pixel. FIG. 4 is a flowchart illustrating the operation of reading a signal from a pixel. FIG. 5 is a diagram illustrating the configuration of lines in the image pickup device in FIG. 2. FIG. 6 is a diagram illustrating an example of a luminance distribution of an object to be the image pickup target. FIG. 7 is a timing chart illustrating the operation of the image pickup device when the image of the object shown in FIG. 6 is picked up.

This image pickup device 1 includes a pixel portion 3, first reading means 5 including first selection means 7, and second reading means 6 including second selection means 8.

The pixel portion 3 includes an array in which a plurality of pixels Pxl are arranged in a vertical direction and in a horizontal direction, that is to say, in a two-dimensional matrix. A pixel-signal read line connected to each pixel Pxl is connected to both the first selection means 7 and the second selection means 8.

The first selection means 7 arbitrarily selects a pixel to be the target of reading a photoelectric conversion signal by the first reading means 5. The photoelectric conversion signal selected by the first selection means 7 and read by the first reading means 5 is output as a first output.

Similarly, the second selection means 8 arbitrarily selects a pixel to be the target of reading a photoelectric conversion signal by the second reading means 6. The selection of a pixel by the second selection means 8 is performed independently of the selection of a pixel by the first selection means 7. The photoelectric conversion signal selected by the second selection means 8 and read by the second reading means 6 is output as a second output.

Accordingly, the photoelectric conversion signal of an arbitrary pixel Pxl included in the pixel portion 3 can be independently read by any of the first reading means 5 and the second reading means 6.

Referring to FIG. 2, a description will be given of an example in which the pixel portion 3 of the image pickup device 1 shown in FIG. 1 includes 4×4 pixels.

As shown in the figure, the pixel portion 3 formed on the image pickup plane includes the pixels Pxl arranged in a two-dimensional array, constituting 4×4 pixels in vertical and horizontal directions, respectively. Line-selection signal lines for selecting a horizontal line (row line) as a read line by outputting a line-selection pulse Lsl described below are connected to the pixels Pxl arranged in the horizontal direction from the vertical scanning/control circuit 13 included in the first selection means 7 and the second selection means 8. In the example shown, four line-selection signal lines are connected to the pixels Pxl from the vertical scanning/control circuit 13. Although not shown in FIG. 2, reset-signal lines are further connected to each pixel Pxl arranged on a horizontal line from the vertical scanning/control circuit 13 to output a gate-charge reset pulse Rst (refer to FIG. 3).

Also, pixel-signal read lines are commonly connected to the pixels Pxl arranged in the vertical direction in the pixels arranged in a two-dimensional array as described above. In the example shown, four pixel-signal read lines as shown by double lines are connected. These pixel-signal read lines are connected to both first reading portion 11 included in the first reading means 5 and second reading portion 12 included in the second reading means 6.

Storage portions M1a and M1b included in the first reading means 5 and storage portions M2a and M2b included in the second reading means 6 are individually connected to each pixel-signal read line. The storage portions M1a and M1b are independently controlled by the first reading portion 11, and the storage portions M2a and M2b are controlled by the second reading portion 12. The details of these storage portions will be described later with reference to FIG. 3.

Next, a description will be given of the configuration to pixels disposed in the pixel portion and the reading portion with reference to FIG. 3. Here, for the sake of simplicity, a description will be given by taking an image pickup device of nondestructive-read type for example. However, the configuration of the present embodiment is not limited to this, and can be applied to an image pickup device of destructive-read type.

The pixel Pxl includes a photodiode PD, and transistors Tr1, Tr2, and Tr3.

The photodiode PD generates a charge in accordance with the amount of light and stores a charge by performing photoelectric conversion of irradiated light on the image pickup device.

The gate, the source, and the drain of the transistor Tr2 are connected to the photodiode PD, the power line, and the transistor Tr3, respectively. The transistor Tr2 converts the charge transferred from the photodiode into a voltage. That is to say, the current that flows between the source and the drain of the transistor Tr2 varies in accordance with the voltage occurring by the charge stored in the gate of the transistor Tr2.

The gate of the transistor Tr1 is connected to a reset-signal line from the vertical scanning/control circuit 13. The source of the transistor Tr1 is connected to the power line. The drain of the transistor Tr1 is connected to the photodiode PD and the gate of the transistor Tr2. The transistor Tr1 resets the charge stored in the photodiode PD and the gate of the transistor Tr2 when receiving a gate-charge reset pulse Rst from the vertical scanning/control circuit 13.

The gate, the source, and the drain of the transistor Tr3 are connected to a line-selection signal line from the vertical scanning/control circuit 13, the transistor Tr2, and the pixel-signal read line Vn, respectively. The transistor Tr3 functions as a switch for turning on/off whether or not the current flowing from the drain of the transistor Tr2 is connected to the pixel-signal read line Vn in accordance with the line-selection pulse Lsl from the vertical scanning/control circuit 13.

A description will be given of the operation of the pixel Pxl described above with reference to FIG. 4.

First, the charge stored by the photodiode PD for a predetermined time period is read on the pixel-signal read line Vn as a photoelectric conversion signal by applying the line-selection pulse Lsl to the gate of the transistor Tr3 (step S1). The photoelectric conversion signal read here is stored in either the memory portion M1a or the memory portion M2a as described below.

Next, the charge stored in the gate of the transistor Tr2 and the photodiode PD is reset by applying a gate-charge reset pulse Rst to the gate of the transistor Tr1 (step S2).

By applying the line-selection pulse Lsl to the transistor Tr3 immediately after the reset, the signal of transistor Tr2 immediately after the reset is read on the pixel-signal read line Vn as a reset signal (step S3). As described below, the reset signal read here is stored in the memory portion M1b if the photoelectric conversion signal is stored in the memory portion M1a in step S1, and is stored in the memory portion M2b if the photoelectric conversion signal is stored in the memory portion M2a in step S1.

When the operation in step S3 is terminated, the processing returns to step S1 and the operations described above are repeated.

Referring back to FIG. 3, a description will be given of the structure of the memory portion.

As described above, the storage portions M1a and M1b included in the first reading means 5 and storage portions M2a and M2b included in the second reading means 6 are individually connected to the pixel-signal read line Vn.

The storage portions M1a and M1b store the signal read from the first reading portion 11. The storage portion M1a includes a switch SW1a and a capacitor C1a. The storage portion M1b includes a switch SW1b and a capacitor C1b. One end of the switches SW1a and SW1b are connected to the pixel-signal read line Vn. The other end of the switches SW1a and SW1b are connected to one end of the capacitors C1a and C1b, respectively. Also, the other end of the capacitors C1a and C1b are individually connected to ground. As described above, the storage portion M1a stores the photoelectric conversion signal read in step S1, and the storage portion M1b stores the reset signal read in step S3.

The storage portions M2a and M2b store the signal read from the second reading portion 12. The storage portion M2a includes a switch SW2a and a capacitor C2a. The storage portion M2b includes a switch SW2b and a capacitor C2b. One end of the switches SW2a and SW2b are connected to the pixel-signal read line Vn. The other end of the switches SW2a and SW2b are connected to one end of the capacitors C2a and C2b, respectively. Also, the other end of the capacitors C2a and C2b are individually connected to ground. The storage portion M2a stores the photoelectric conversion signal read in step S1, and the storage portion M2b stores the reset signal read in step S3.

In the storage portion having such configuration, when a photoelectric conversion signal is stored in the capacitor C1a, only the switch SW1a is turned on and the switches SW1b, SW2a, and SW2b are turned off. Similarly, when a reset signal is stored in the capacitor C1b, only the switch SW1b is turned on and the switches SW1a, SW2a, and SW2b are turned off. When a photoelectric conversion signal is stored in the capacitor C2a, only the switch SW2a is turned on and the switches SW1a, SW1b, and SW2b are turned off. When a reset signal is stored in the capacitor C2b, only the switch SW2b is turned on and the switches SW1a, SW1b, and SW2a are turned off.

The storage portion M1a and the storage portion M1b are arranged as a pair. As described below, by subtracting the reset signal stored in the storage portion 1b from the photoelectric conversion signal stored in the storage portion M1a, a noise component called fixed-pattern noise (FPN) individually occurring in each pixel is reduced. The first output from the first reading portion 11 is the output after the subtraction of the noise component is performed.

Similarly, the storage portion M2a and the storage portion M2b are arranged as a pair. By subtracting the reset signal stored in the storage portion 2b from the photoelectric conversion signal stored in the storage portion M2a, fixed-pattern noise is reduced. The second output from the second reading portion 12 is the output after the subtraction of the noise component is performed.

The line structure in the image pickup device 1 including the 4×4 matrix as shown in FIG. 2 is shown in FIG. 5. Each of the lines including the first line to the fourth line is a line selected by the line-selection pulse Lsl from the vertical scanning/control circuit 13. As shown in FIG. 5, for example, when the first line is selected, the line-selection pulse Lsl1 as shown in FIG. 7 described below should be applied to the line selection signal line of the first line.

FIG. 7 shows an example of the output signal when the image of an object OBJ shown in FIG. 6 is picked up by the image pickup device 1 having such a configuration. The object OBJ shown in FIG. 6 has gradations of luminance which linearly changes only in a horizontal direction and has the same luminance when the horizontal positions are the same even if the vertical positions are different.

The image pickup sequence shown in FIG. 7 is the operation when the image of the object as shown in FIG. 6 is picked up by the image pickup device 1 and the first-line to fourth-line signals are read in this sequence by the first reading portion 11, and only the first-line signal is read repeatedly by the second reading portion 12. That is to say, the first reading portion 11 reads the photoelectric conversion signals in the sequence of: first line→second line→third line→fourth line→first line→ . . . . Also, the second reading portion 12 reads the photoelectric conversion signals in the sequence of: first line→first line→first line→first line→first line→ . . . .

Such a selection of line to be read is individually performed by the first selection means 7 for the first reading means 5, and by the second selection means 8 for the second reading means 6. As described above, the first selection means 7 and the second selection means 8 arbitrarily selects a pixel from which a photoelectric conversion signal is read by the first reading means 5 and the second reading means 6, respectively from all the pixel area. Accordingly, in the example as shown in FIG. 7, the first selection means 7 selects all the pixels of the pixel portion 3 for each line, and the second selection means 8 repeatedly selects only the pixels of the first line of the pixel portion 3.

As shown in FIG. 7, a vertical reading period for outputting the image signal of one frame includes horizontal reading periods for 4 lines. As shown in the horizontal synchronization signal, each horizontal reading period includes a horizontal blanking period and a horizontal valid signal period. The signal from each pixel Pxl is read together for each line during the horizontal blanking period. In this regard, in FIG. 7, for the sake of simplicity, the illustration of vertical blanking periods is omitted.

Also, in FIG. 7, Lsln and Rstn denote control pulses (a line-selection pulse and a gate-charge reset pulse) for controlling n-th line (n=1, . . . , 4), respectively. Reference symbols S1 to S3 attached to the waveform of these control pulses denote each step in the flowchart shown in FIG. 4. Also, the numerals “1” or “2” attached under the waveform denote the operations regarding the first output from the first reading portion 11 and the second output from the second reading portion 12, respectively.

First, in order to read a photoelectric conversion signal from the pixel Pxl disposed in the first line by the line-selection pulse Lsl1, the operation of step S1 is performed, the photoelectric conversion signal for the first output is read for the first reading portion 11, and the photoelectric conversion signal for the second output is read for the second reading portion 12. Thus, the photoelectric conversion signal from each pixel Pxl arranged in the first line is transferred to each capacitor C1a included in the first reading means 5 and each capacitor C2a included in the second reading means 6, respectively.

Thereafter, the operation of step S2 is performed so that the charge stored in the photodiode PD of all the pixels arranged in the first line is reset by the gate-charge reset pulse Rst1. After this reset is performed, the storage of new charge is started in the first line. The gate-charge reset pulse Rst1 is output in the horizontal blanking period for each one frame. In each one frame, the same operation is repeated. The period until the next reset is the period for storing the charge in the photodiode PD.

Immediately after the reset operation is performed, the operation of step S3 is performed to output the line-selection pulse Lsl1, thereby reading the signal from the pixel Pxl immediately after the reset. The signal read here is transferred to each capacitor C1b included in the first reading means 5 and each capacitor C2b included in the second reading means 6, respectively, and is stored as a reset signal.

The first reading portion 11 calculates the difference between the photoelectric conversion signal stored in the capacitor C1a and the reset signal stored in the capacitor C1b to reduce the fixed-pattern noise (FPN), and then transfers the signal as the first output.

Similarly, the second reading portion 12 calculates the difference between the photoelectric conversion signal stored in the capacitor C2a and the reset signal stored in the capacitor C2b to reduce the fixed-pattern noise (FPN), and then transfers the signal as the second output.

In the example shown in FIG. 7, in the first horizontal valid signal period in one frame, the signal Sig1a output from the first reading portion 11 and the Sig2a output from the second reading portion 12 are basically the same.

In the next horizontal reading period (the second reading period in one frame), first, the operation of step S1 is performed, that is to say, the line-selection pulse Lsl1 reads the photoelectric conversion signal from the pixel Pxl disposed in the first line, and transfers the signal to each capacitor C2a included in the second reading means 6.

Subsequently, the operation of step S1 is performed, that is to say, the line-selection pulse Lsl2 reads the photoelectric conversion signal from the pixel Pxl disposed in the second line, and transfers the signal to each capacitor C1a included in the first reading means 5.

Next, the operation of step S2 is performed, that is to say, the gate-charge reset pulse Rst2 resets the charge stored in the photodiode PD of all the pixels disposed in the second line. Accordingly, the end timing (or the start timing) of the storage period in the second line is shifted nearly one horizontal reading period from the end timing (or the start timing) of the storage period in the first line.

Immediately after the reset operation is performed, the operation of step S3 is performed, that is to say, by outputting the line-selection pulse Lsl2, the signal from each pixel Pxl of the second line immediately after the reset is read to transfer the signal as the reset signal to each capacitor C1b included in the first reading means 5.

In the horizontal valid signal period in the second horizontal reading period, the first reading portion 11 and the second reading portion 12 calculate the difference between the photoelectric conversion signal and the reset signal to output it in the same manner as described above. At this time, the signal Sig1b, that is, the first output from the first reading portion 11 is the second-line signal produced by the charge stored during the storage period corresponding to nearly one vertical reading period. However, the signal Sig2b, that is, the second output from the second reading portion 12 is the first-line signal produced by the charge stored during the storage period corresponding to nearly one horizontal reading period. Accordingly, the level of the signal Sig2b is nearly one fourth of the signal Sig2a.

Furthermore, the operation of the next horizontal reading period (the third horizontal reading period in one frame) is nearly the same as the operation in the second horizontal reading period described above. Although the second reading portion 12 reads the first line to output the signal Sig2c, the first reading portion 11 differently reads the third line to output the signal Sig1c. In this regard, the signal Sig2c becomes the signal produced by storing the charge for a storage period corresponding to nearly two horizontal reading periods.

The operation of the next horizontal reading period (the fourth horizontal reading period in one frame) is nearly the same as the operation of the second horizontal reading period described above. Although the second reading portion 12 reads the first line to output the signal Sig2d, the first reading portion 11 differently reads the fourth line to output the signal Sig1d. In this regard, the signal Sig2d becomes the signal produced by storing the charge for a storage period corresponding to nearly three horizontal reading periods.

In this regard, in the example shown in FIG. 7, in the horizontal blanking period of the second to the fourth horizontal reading periods, first, the reading for the second output is performed, and then the reading for the first output is performed. However, the sequence is not limited to this. The reading for the first output may be performed first, and then the reading for the second output may be performed.

Also, since the second output is produced by reading the same line a plurality of times in one vertical reading period, the levels of the signals Sig2a to Sig2d differ individually. Such an output signal is inconvenient for directly using for AF and AE, and thus the difference from the output signal of the previous horizontal reading period should be calculated as described below to output as an operation signal.

That is to say, in the first horizontal reading period, the difference (Sig2a−Sig2d) between the obtained signal Sig2a and the signal Sig2d obtained in the fourth horizontal reading period of the previous frame is calculated and used as the output for various processing.

Also, in the second horizontal reading period, since the obtained signal Sig2b has a storage of nearly one horizontal reading period, the signal Sig2b is directly used as the output for various processing.

Subsequently, in the third horizontal reading period, in the same manner as the first horizontal reading period described above, the difference (Sig2c−Sig2b) between the obtained signal Sig2c and the signal Sig2b obtained in the second horizontal reading period is calculated and used as the output for various processing.

Thereafter in the fourth horizontal reading period, in the same manner as the third horizontal reading period described above, the difference (Sig2d−Sig2c) between the obtained signal Sig2d and the signal Sig2c obtained in the third horizontal reading period is calculated and used as the output for various processing.

The signal obtained by calculating such a difference becomes a signal having a storage period of nearly one horizontal reading period and having a storage period shorter than that of one frame.

By performing the above-described processing, the image pickup signals for all the pixels in the pixel portion 3 for forming an ordinary image is obtained from the first reading portion 11 for one-frame period. At the same time, the signals for a specific area (first line in this example) is obtained from the second reading portion 12 for a plurality of times in one-frame period. The signal of the specific area is a signal having a level in accordance with the storage time roughly indicating how many horizontal reading periods have passed from different storage start point in time for each line.

In this regard, in the example described above, the second reading portion 12 obtains only the signal of the first line repeatedly. However, when the signals of a sub-area (namely, a sub-area of the all the pixel area of the pixel portion 3) extending over a plurality of lines are necessary, the signals of the line including that sub-area should be repeatedly read in sequence in a frame period. Thus, the signals of that sub-area can be obtained a plurality of times in one-frame period.

In this way, since a plurality of signals are obtained in one-frame period from the second reading portion 12, by using these signals for image-pickup control signals, such as AF, AE, etc., the changes of a shooting state can be obtained at a high speed, thereby making it possible to perform high-speed image-pickup control.

In general, in the processing of AE, AF, etc., the information on all the pixels of the pixel portion 3 is not necessary. The information on only a part of area (for example, the central part of the pixel portion 3 to be an image pickup area, or a noticed object portion) is necessary. Accordingly, it becomes possible to perform high-speed image-pickup control described above for almost all the shooting scenes.

A sub-area necessary for image-pickup control dynamically changes in accordance with a shooting scene, and thus the control should be performed such that the line to be the target of the reading from the second reading portion 12 be changed in accordance with the shooting scene.

Also, when the signals of all the image pickup area is schematically required, it becomes possible to read twice in one-frame period by reading, for example, one out of two lines from the second reading portion 12, thereby making it possible to obtain the entire state. Such thinned-out reading is, of course, not limited to one out of two lines. It is possible to read n lines (n is an integer of one or more, and satisfies n<m) out of m lines (m is an integer of 2 or more). Thus, it is possible to obtain an image with normal frame rate for all the pixels of the pixel portion 3. At the same time, it becomes possible to obtain an image read by thinning-out with high-speed frame rate.

In this regard, in the above description, for the sake of simplicity, two reading means are used. However, the number of the reading means is not limited to this. It is of course possible to provide two or any more number of reading means, and to individually perform the reading of the pixels independently. In this case, it becomes possible to perform control, etc. at a higher speed.

According to the first embodiment described above, it is possible to obtain normal image-pickup signals for all the pixel of the pixel portion in one-frame period, and at the same time, it is possible to obtain image-pickup signals for a part of pixels of the pixel portion in that one-frame period a plurality of times. Accordingly, by using the image-pickup signals obtained a plurality of times in one frame, it becomes possible to perform image-pickup control operations, such as AE and AF, and at the same time, it becomes possible to use the signals for the other various purposes.

Also, since the line to be read can be arbitrarily selected, and thus it becomes possible to dynamically adapt to various shooting scenes to perform best-suited reading.

### Second Embodiment

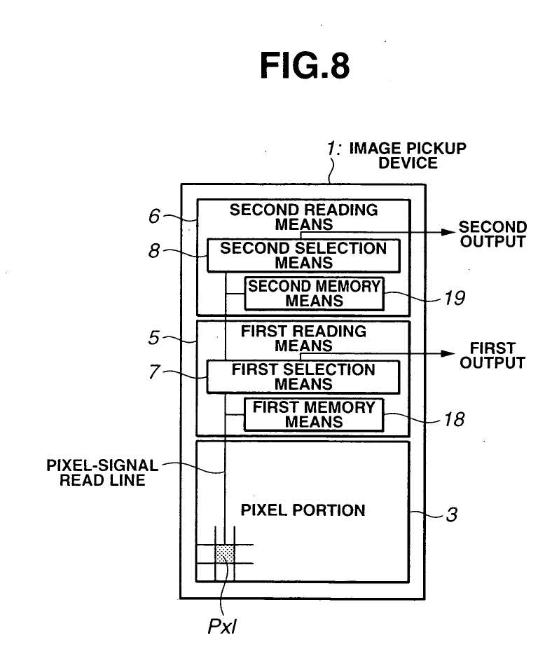

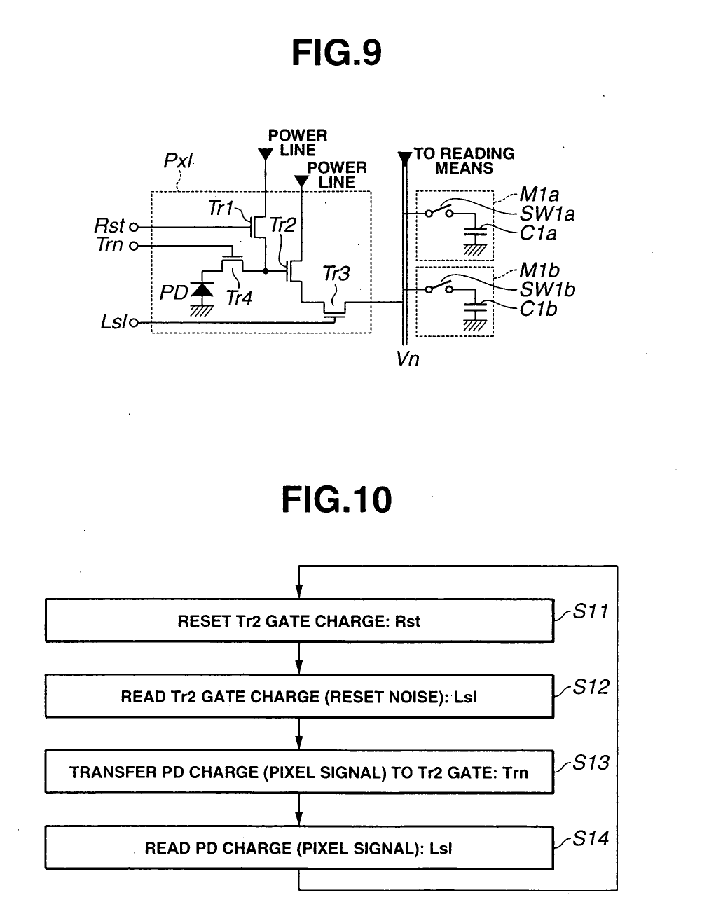

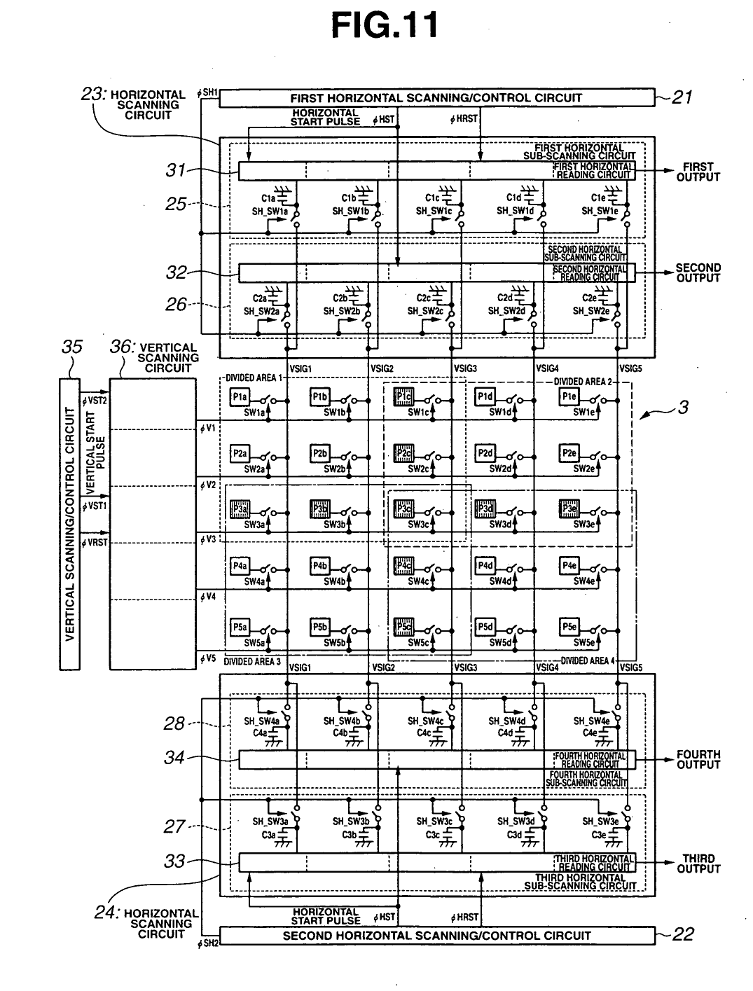

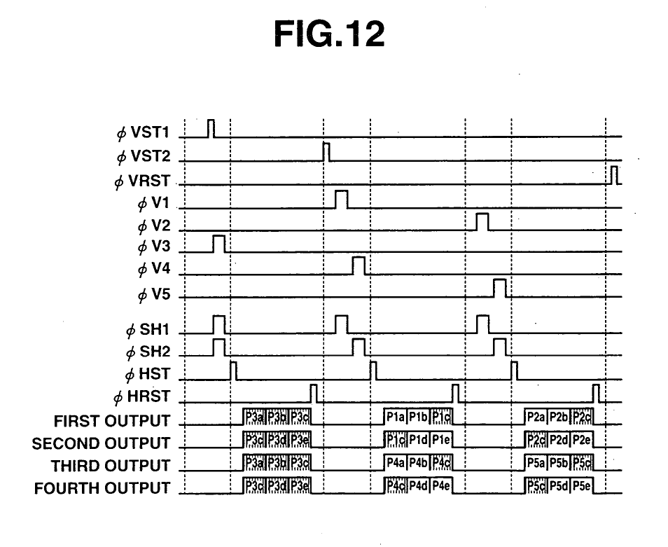

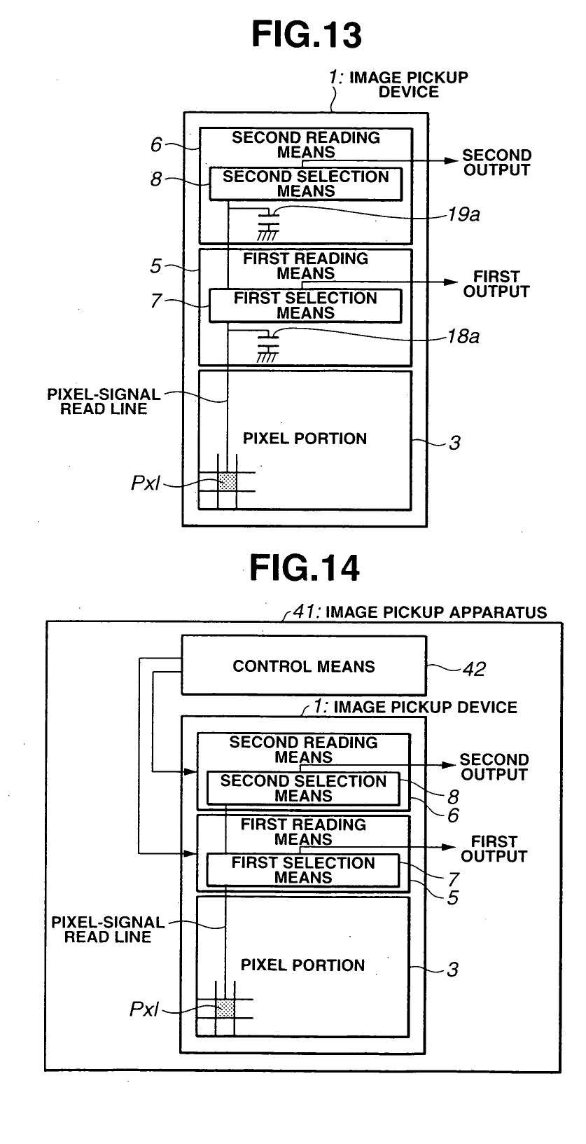

FIGS. 8 to 13 illustrate a second embodiment of the present invention. FIG. 8 is a block diagram illustrating a schematic configuration of an image pickup device. FIG. 9 is a circuit diagram illustrating a specific example of the configuration of a pixel used in the image pickup device. FIG. 10 is a flowchart illustrating the operation of reading a signal from the pixel shown in FIG. 9. FIG. 11 is a diagram illustrating an example of an image pickup device including 5×5 pixels. FIG. 12 is a timing chart illustrating the operation of the image pickup device when an image is picked up by the image pickup device shown in FIG. 11. FIG. 13 is a diagram illustrating an example in which memory means includes a capacitor in the image pickup device shown in FIG. 8.

In the second embodiment, the same parts as those of the first embodiment described above are marked with the same reference symbols, and the descriptions thereof are omitted. A description will be mainly given only of the different parts.

As shown in FIG. 8, in an image pickup device 1 according to the second embodiment, first memory means 18 and second memory means 19 are provided with the first reading means 5 and the second reading means 6, respectively. That is to say, a plurality of reading means are provided with memory means, respectively. Thus, if there are three or more reading means, each reading means is provided with individual memory means. Also, image pickup device 1 shown in FIG. 13 illustrates an example in which the memory means is constructed by a capacitor. The first memory means 18 and the second memory means 19 are replaced with a first capacitor 18a and a second capacitor 19a, respectively. It is relatively easy to arrange a capacitor on a semiconductor substrate, and control such as the control of a transistor, etc., is unnecessary. Thus, it is one of the best suited means for use as the memory means described above.

Next, a description will be given of an example of the configuration of a pixel in the image pickup device according to the second embodiment with reference to FIG. 9. A destructive-read type image pickup device is used in the second embodiment, for example.

As shown in FIG. 9, in the pixel Pxl included in the destructive-read type image pickup device, a transistor Tr4 is disposed between the photodiode PD and the transistor Tr2.

The gate of the transistor Tr4 is connected to the gate-transfer signal line Trn of the vertical scanning/control circuit 35 (refer to FIG. 11). The source of the transistor Tr4 is connected to the photodiode PD. The drain of the transistor Tr4 is connected to the gate of the transistor Tr2 and the drain of the transistor Tr1. This transistor Tr4 functions as a switch on whether or not the charge stored in the photodiode PD is transferred to the gate of the transistor Tr2.

In this regard, in FIG. 9, for the sake of simplicity, only one pair of memory portions (a memory portion M1a and a memory portion M1b) regarding one reading means is shown in the figure. However, in the same manner as the first embodiment described above, the pairs of the memory portions are disposed in accordance with the number of reading means.

The reading operation of a pixel having such a configuration is the same as the outline described in Description of the Related Art described above with reference to FIG. 10.

That is to say, by applying the gate-charge reset pulse Rst to the gate of the transistor Tr1, the charge stored in the gate of the transistor Tr2 is reset (step S11). Thus, the charge stored so far is flushed to perform so-called destruction.

Immediately after this reset is performed, by applying a line-selection pulse Ls1 to the transistor Tr3, the signal of the transistor Tr2 immediately after the reset is read on the pixel-signal read line Vn as the reset signal (step S12). The reset signal read here is stored in the memory portion M1b.

Thereafter, the photodiode PD stores the charge for a predetermined time. After an elapse of a predetermined time period, by applying the gate-transfer signal line Trn to turn on the transistor Tr4, the photoelectric conversion signal stored in the photodiode PD is transferred to the gate of the transistor Tr2 (step S13).

Subsequently, by applying a line-selection pulse Ls1 to the gate of the transistor Tr3, the charge stored in the gate of the transistor Tr2 is read on the pixel-signal read line Vn as the photoelectric conversion signal (step S14). The photoelectric conversion signal read here is stored in the memory portion M1a. By calculating the difference between the photoelectric conversion signal stored in the memory portion M1a and the reset signal stored in the memory portion M1b, noise is reduced in the same manner as the first embodiment described above.

When the operation of step S14 is completed, the processing returns to step S11, and the operation described above is repeated.

Next, a description will be given of the image pickup device including 5×5 pixels with reference to FIG. 11. In order to describe the way of reading in the second embodiment, an example in which a pixel portion 3 includes 5×5 pixels is shown.

This image pickup device includes the pixel portion 3, a vertical scanning circuit 36, a vertical scanning/control circuit 35, horizontal scanning circuits 23 and 24, a first horizontal scanning/control circuit 21, and a second horizontal scanning/control circuit 22.

The pixel portion 3 includes pixels P1a to P5e disposed in a matrix state for storing charges in accordance with incident light and row-selection switches SW1a to SW5e provided corresponding to each of the pixels P1a to P5e with one-to-one relationship for switching whether or not to read each corresponding pixel. In this regard, in the pixels P1a to P5e and the row-selection switches SW1a to SW5e, the numerals 1 to 5 included in the reference numerals indicate row numbers of the matrix-state array, and the alphabet lowercase letters a to e after the numerals indicate column numbers of the matrix-state array. Each of the pixels P1a to P5e is connected to each of the pixel-signal read line VSIG1 to VSIG5 with the same column number through the row-selection switches SW1a to SW5e, respectively. Also, each of the row-selection switches SW1a to SW5e is connected to each of line-selection signal lines φV1 to φV5 with the same row number. Also, all the pixel area of the pixel portion 3 is divided into two in the vertical direction and is divided into two in the horizontal direction. That is to say, the area is divided into four divided areas 1 to 4. In this regard, the division into four is used as an example. However, the division is not limited to this, and it is possible to divide into any number. These divided areas 1 to 4 are not configured exclusively, but are configured such that a divided area includes common pixels with the other divided areas adjacent horizontally and vertically. Specifically, the divided area 1 disposed upper left includes the pixels P1a to P1c, P2a to P2c, and P3a to P3c; the divided area 2 disposed upper right includes the pixels P1c to P1e, P2c to P2e, and P3c to P3e; the divided area 3 disposed lower left includes the pixels P3a to P3c, P4a to P4c, and P5a to P5c; and the divided area 4 disposed lower right includes the pixels P3c to P3e, P4c to P4e, and P5c to P5e. The pixels marked by halftone dot P1c, P2c, P3a to P3e, P4c, and P5c are overlapped pixels included in a plurality of divided areas.

The vertical scanning circuit 36 is selection means for controlling the operation of the row-selection switches SW1a to SW5e by selectively supplying a line-selection pulse to any one of the line-selection signal lines φV1 to φV5. When vertical-start pulses φVST1 and φVST2 described below are supplied from the vertical scanning/control circuit 35, the vertical scanning circuit 36 supplies a line-selection pulse so as to start reading the row specified by the vertical-start pulses φVST1 and φVST2, and then supplies a line-selection pulse for reading the next row at a predetermined clock timing. The supplying of the line-selection pulses is reset when the vertical scanning/control circuit 35 supplies a vertical-reset pulse φVRST.

The vertical scanning/control circuit 35 is selection means for controlling the operation of the vertical scanning circuit 36. That is to say, the vertical scanning/control circuit 35 supplies the vertical-start pulses φVST1 and φVST2 to the vertical scanning circuit 36, thereby controlling the line to start reading. Also, the vertical scanning/control circuit 35 supplies the vertical-reset pulse φVRST to the vertical scanning circuit 36, thereby controlling to reset the row-selection of the vertical scanning circuit 36.

The horizontal scanning circuits 23 and 24 reads the charge of the pixel selected by the vertical scanning circuit 36 to output it. The horizontal scanning circuit 23 includes a first horizontal sub-scanning circuit 25 and a second horizontal sub-scanning circuit 26. Similarly, the horizontal scanning circuit 24 includes a third horizontal sub-scanning circuit 27 and a fourth horizontal sub-scanning circuit 28. As described above, although an example of providing two systems of reading means is shown in FIG. 8, an example of providing four systems of reading means is shown in FIG. 11. Furthermore, each of the horizontal sub-scanning circuits 25 to 28 includes a horizontal reading circuit, and a sample-hold capacitor and a sample-hold switch corresponding to each of the plurality of pixel-signal read lines. Specifically, the first horizontal sub-scanning circuit 25 includes: reading means, namely, a first horizontal reading circuit 31; capacitors C1a to C1e, one end of which is connected to the first horizontal reading circuit 31, and the other end of which is connected to ground, for serving as memory means and sample-hold capacitance; and sample-hold switches SH_SW1a to SH_SW1e, one end of which is connected to each of the capacitors C1a to C1e, and the other end of which is connected to the pixel-signal read line, for serving as selection means. Also, the second horizontal sub-scanning circuit 26 includes: reading means, namely, a second horizontal reading circuit 32; capacitors C2a to C2e, one end of which is connected to the second horizontal reading circuit 32, and the other end of which is connected to ground, for serving as memory means and sample-hold capacitance; and sample-hold switches SH_SW2a to SH_SW2e, one end of which is connected to each of capacitors C2a to C2e, and the other end of which is connected to the pixel-signal read line, for serving as selection means. Furthermore, the third horizontal sub-scanning circuit 27 includes: reading means, namely, a third horizontal reading circuit 33; capacitors C3a to C3e, one end of which is connected to the third horizontal reading circuit 33, and the other end of which is connected to ground, for serving as memory means and sample-hold capacitance; and sample-hold switches SH_SW3a to SH_SW3e, one end of which is connected to each of capacitors C3a to C3e, and the other end of which is connected to the pixel-signal read line, for serving as selection means. The fourth horizontal sub-scanning circuit 28 includes: reading means, namely, a fourth horizontal reading circuit 34; capacitors C4a to C4e, one end of which is connected to the fourth horizontal reading circuit 34, and the other end of which is connected to ground, for serving as memory means and sample-hold capacitance; and sample-hold switches SH_SW4a to SH_SW4e, one end of which is connected to each of capacitors C4a to C4e, and the other end of which is connected to the pixel-signal read line, for serving as selection means. The sample-hold switches SH_SW1a to SH_SW2e are connected to a sample-hold control signal line coming from the first horizontal scanning/control circuit 21, and are controlled by being supplied with a sample-hold control signal φSH1. Similarly, the sample-hold switches SH_SW3a to SH_SW4e are connected to a sample-hold control signal line coming from the second horizontal scanning/control circuit 22, and are controlled by being supplied with a sample-hold control signal φSH2. A horizontal-start pulse φHST is supplied to the first horizontal reading circuit 31 and the second horizontal reading circuit 32 from the first horizontal scanning/control circuit 21. Furthermore, the horizontal reset pulse φHRST is also supplied to the first horizontal reading circuit 31 from the first horizontal scanning/control circuit 21. Similarly, a horizontal-start pulse φHST is supplied to the third horizontal reading circuit 33 and the fourth horizontal reading circuit 34 from the second horizontal scanning/control circuit 22. Furthermore, the horizontal reset pulse φHRST is also supplied to the third horizontal reading circuit 33 from the second horizontal scanning/control circuit 22.

The first horizontal scanning/control circuit 21 and the second horizontal scanning/control circuit 22 are selection means for controlling the operation of the horizontal scanning circuits 23 and 24, respectively. That is to say, the first horizontal scanning/control circuit 21 supplies the sample-hold control signal φSH1, thereby controlling to store the charges of the pixels arranged in the row selected by the vertical scanning circuit 36 into the capacitors C1a to C1e and the capacitors C2a to C2e, respectively. Similarly, the second horizontal scanning/control circuit 22 supplies the sample-hold control signal φSH2, thereby controlling to store the charges of the pixels arranged in the row selected by the vertical scanning circuit 36 into the capacitors C3a to C3e and the capacitors C4a to C4e, respectively. Also, the first horizontal scanning/control circuit 21 supplies the horizontal-start pulse φHST, thereby controlling the reading-start position in the first horizontal reading circuit 31 and the reading-start position in the second horizontal reading circuit 32. Furthermore, the first horizontal scanning/control circuit 21 supplies the horizontal-reset pulse φHRST to the first horizontal reading circuit 31, thereby controlling to reset the reading by first horizontal reading circuit 31 and the second horizontal reading circuit 32. Similarly, the second horizontal scanning/control circuit 22 supplies the horizontal-start pulse φHST, thereby controlling the reading-start position in the third horizontal reading, circuit 33 and the reading-start position in the fourth horizontal reading circuit 34. Furthermore, the second horizontal scanning/control circuit 22 supplies the horizontal-reset pulse φHRST to the third horizontal reading circuit 33, thereby controlling to reset the reading by third horizontal reading circuit 33 and the fourth horizontal reading circuit 34.

Subsequently, with reference to FIG. 12, a description will be given of the sequence when picking up images by the image pickup device having the configuration shown in FIG. 11 and the state of the photoelectric conversion signal obtained by this sequence.

First, the vertical scanning/control circuit 35 applies the vertical-start pulse φVST1 to the vertical scanning circuit 36. Then the vertical scanning circuit 36 selects the line-selection signal line φV3, which is a row-selection line. Thus, the signals from the pixels P3a to P3e are transferred onto the pixel-signal read lines VSIG1 to VSIG5 through the row-selection switches SW3a to SW3e.

At this time, when the first horizontal scanning/control circuit 21 outputs the sample-hold control signal φSH1, the signals transferred to the pixel-signal read lines VSIG1 to VSIG5 are saved in the capacitors C1a to C1e through the sample-hold switches SH_SW1a to SH_SW1e included in the first horizontal sub-scanning circuit 25. At the same time, the signals transferred to the pixel-signal read lines VSIG1 to VSIG5 are saved in the capacitors C2a to C2e through the sample-hold switches SH_SW2a to SH_SW2e included in the second horizontal sub-scanning circuit 26.

Also, when the second horizontal scanning/control circuit 22 outputs the sample-hold control signal φSH2, the signals transferred to the pixel-signal read lines VSIG1 to VSIG5 are saved in the capacitors C3a to C3e through the sample-hold switches SH_SW3a to SH_SW3e included in the third horizontal sub-scanning circuit 27. At the same time, the signals transferred to the pixel-signal read lines VSIG1 to VSIG5 are saved in the capacitors C4a to C4e through the sample-hold switches SH_SW4a to SH_SW4e included in the fourth horizontal sub-scanning circuit 28.

Thereafter the sample-hold switches SH_SW1a to SH_SW4e are opened to disconnect the pixel-signal read lines VSIG1 to VSIG5 from the capacitors C1a to C4e. After this disconnection is performed, the first horizontal scanning/control circuit 21 and the second horizontal scanning/control circuit 22 apply the horizontal-start pulse φHST to the first horizontal reading circuit 31 and the second horizontal reading circuit 32, and the third horizontal reading circuit 33 and the fourth horizontal reading circuit 34. By doing this, the signals of the pixels P3a to P3c saved in the capacitors C1a to C1c are read from the first horizontal reading circuit 31 as the first output, the signals of the pixels P3c to P3e saved in the capacitors C2c to C2e are read from the second horizontal reading circuit 32 as the second output, the signals of the pixels P3a to P3c saved in the capacitors C3a to C3e are read from the third horizontal reading circuit 33 as the third output, and the signals of the pixels P3c to P3e saved in the capacitors C4c to C4e are read from the fourth horizontal reading circuit 34 as the fourth output in sequence, respectively.

After necessary pixel signals have been read, the first horizontal scanning/control circuit 21 and the second horizontal scanning/control circuit 22 apply the horizontal-reset pulse φHRST to the first horizontal reading circuit 31 and the third horizontal reading circuit 33, thereby stopping the operation of the first horizontal sub-scanning circuit 25 and the third horizontal sub-scanning circuit 27 to terminate the reading of the pixels P3a to P3e.

By the reading operations described above, that is to say, by once saving the signals of the pixels P3a, P3b, P3c, P3d, and P3e of the selected row in the capacitors C1a to C4e included in the first to fourth horizontal sub-scanning circuits 25 to 28 corresponding to a plurality of output lines, respectively, and then reading them, it becomes possible to obtain the signals of the pixels P3a, P3b, P3c, P3d, and P3e from a plurality of output lines. Thus, although the image pickup device includes destructive-read type pixels, it is possible to read the output signal of the same pixel from a plurality of output terminals. In addition, the sampling timing of the signals from the pixels P3a to P3e for the capacitors C1a to C4e.

Next, the vertical scanning/control circuit 35 applies the vertical-start pulse φVST2 to the vertical scanning circuit 36. Then the vertical scanning circuit 36 selects the line-selection signal line φV1, which is a row-selection line. Thus, the signals from the pixels P1a to P1e are transferred onto the pixel-signal read lines VSIG1 to VSIG5 through the row-selection switches SW1a to SW1e.

At this time, when the first horizontal scanning/control circuit 21 outputs the sample-hold control signal φSH1, the signals transferred to the pixel-signal read lines VSIG1 to VSIG5 are saved in the capacitors C1a to C1e through the sample-hold switches SH_SW1a to SH_SW1e included in the first horizontal sub-scanning circuit 25. At the same time, the signals transferred to the pixel-signal read lines VSIG1 to VSIG5 are saved in the capacitors C2a to C2e through the sample-hold switches SH_SW2a to SH_SW2e included in the second horizontal sub-scanning circuit 26.

Thereafter the sample-hold switches SH_SW1a to SH_SW2e are opened to disconnect the pixel-signal read lines VSIG1 to VSIG5 from the capacitors C1a to C2e, thereby terminating the reading of the signals from the pixels P1a to P1e.

Next, the vertical scanning circuit 36 selects the line-selection signal line φV4, which is a row-selection line. Thus, the signals from the pixels P4a to P4e are transferred onto the pixel-signal read lines VSIG1 to VSIG5 through the row-selection switches SW4a to SW4e.

At this time, when the second horizontal scanning/control circuit 22 outputs the sample-hold control signal φSH2, the signals transferred to the pixel-signal read lines VSIG1 to VSIG5 are saved in the capacitors C3a to C3e through the sample-hold switches SH_SW3a to SH_SW3e included in the third horizontal sub-scanning circuit 27. At the same time, the signals transferred to the pixel-signal read lines VSIG1 to VSIG5 are saved in the capacitors C4a to C4e through the sample-hold switches SH_SW4a to SH_SW4e included in the fourth horizontal sub-scanning circuit 28.

Thereafter the sample-hold switches SH_SW3a to SH_SW4e are opened to disconnect the pixel-signal read lines VSIG1 to VSIG5 from the capacitors C3a to C4e, thereby terminating the reading of the signals from the pixels P4a to P4e.

In this manner, after having read the charge from the pixels to the capacitors C1a to C4e, the first horizontal scanning/control circuit 21 and the second horizontal scanning/control circuit 22 apply the horizontal-start pulse φHST to the first horizontal reading circuit 31 and the second horizontal reading circuit 32, and the third horizontal reading circuit 33 and the fourth horizontal reading circuit 34, respectively. By doing this, the signals of the pixels P1a to P1c saved in the capacitors C1a to C1e are read from the first horizontal reading circuit 31 as the first output, the signals of the pixels P1c to P1e saved in the capacitors C2c to C2e are read from the second horizontal reading circuit 32 as the second output, the signals of the pixels P4a to P4c saved in the capacitors C3a to C3e are read from the third horizontal reading circuit 33 as the third output, and the signals of the pixels P4c to P4e saved in the capacitors C4c to C4e are read from the fourth horizontal reading circuit 34 as the fourth output in sequence, respectively.

After necessary pixel signals have been read, the first horizontal scanning/control circuit 21 and the second horizontal scanning/control circuit 22 apply the horizontal-reset pulse φHRST to the first horizontal reading circuit 31 and the third horizontal reading circuit 33, thereby stopping the operation of the first horizontal sub-scanning circuit 25 and the third horizontal sub-scanning circuit 27 to terminate the reading of the pixels P1a to P1e and the pixels P4a to P4e.

Thereafter, by performing substantially the same operation as the reading of the above-described pixels P1a to P1e and pixels P4a to P4e, the reading of the pixels P2a to P2e and the pixels P5a to P5e are performed.

When the reading of the pixels P2a to P2e and the pixels P5a to P5e are terminated, the vertical scanning/control circuit 35 supplies the vertical-reset pulse φVRST to the vertical scanning circuit 36 thereafter. Thus, the operation of the vertical scanning circuit 36 is stopped to terminate row-selection.

As a result of the reading as described above, the first output from the first horizontal reading circuit 31 becomes the pixel signals read from the divided area 1, the second output from the second horizontal reading circuit 32 becomes the pixel signals read from the divided area 2, the third output from the third horizontal reading circuit 33 becomes the pixel signals read from the divided area 3, and the fourth output from the fourth horizontal reading circuit 34 becomes the pixel signals read from the divided area 4.

The signals of the pixels P1c, P2c, P3a, P3b, P3c, P3d, P3e, P4c, and P5c, which are marked by halftone dot in FIG. 11, are obtained from a plurality of corresponding output lines among the first to the fourth outputs in an overlapping manner as shown by halftone dot in FIG. 12.

In this regard, in the above, a description has been given of the case where all the areas of the pixel portion divided into four are independently read from all four system output. However, not all the four systems need to be read, and it is possible to selectively read necessary systems. For example, when signals are read from only two systems out of four systems, it is possible to achieve the operation by performing the same operation as described above.

According to the second embodiment described above, substantially the same effect as that of the first embodiment is obtained. Also, even if the image pickup device is a destructive type, it becomes possible to output a plurality of sub-screens having partially overlapped areas in real time with a simple configuration without necessitating an additional frame memory, etc., externally. Also, when only necessary sub-screens are read from an image pickup device having a large number of pixels, it is possible to read at a lower frame rate than that of reading all the pixels, thereby making it possible to reduce power consumption.

### Third Embodiment

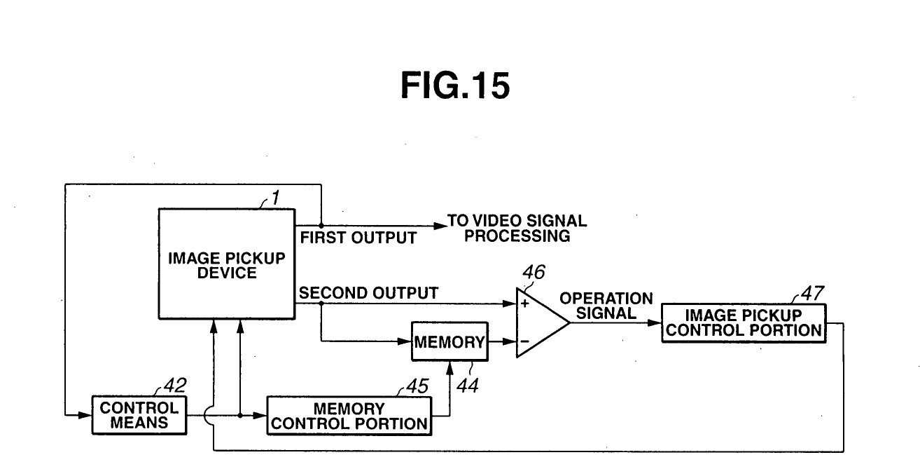

FIGS. 14 and 15 shows a third embodiment of the present invention. FIG. 14 is a block diagram illustrating an image pickup apparatus including an image pickup device. FIG. 15 is a block diagram illustrating the configuration of the image pickup apparatus for performing image-pickup control based on output signals from the image pickup device.

In the third embodiment, the same parts as those of the first and the second embodiments described above are marked with the same reference symbols, and the descriptions thereof are omitted. A description will be mainly given only of the different parts.

This image pickup apparatus is an apparatus in which an image pickup device 1 as shown in FIG. 1 of the first embodiment described above is built in an image pickup apparatus 41.

Specifically, the image pickup apparatus 41 includes the image pickup device 1, control means 42 for controlling the first reading means 5 and the second reading means 6 of the image pickup device 1.

FIG. 15 specifically shows an example of the configuration of the image pickup apparatus 41 which is constructed such that image-pickup control can be performed based on the output of the image pickup device.

The image pickup apparatus shown in FIG. 15 includes the image pickup device 1, the control means 42, and furthermore, a memory 44, a differential circuit 46, an image-pickup control portion 47, and a memory control portion 45.

The first output of the image pickup device 1 is connected to video-signal processing, and to the control means 42.

The control means 42 controls the image pickup device 1 based on the first output, and controls the memory 44 through the memory control portion 45.

Also, the second output of the image pickup device 1 branches. One of the branches is connected to the differential circuit 46, and the other of the branches is connected the differential circuit 46 through the memory 44. This differential circuit 46 serves to output an operation signal as shown in FIG. 7. That is to say, the signals output as the second output have different storage periods, and thus the differential circuit 46 operates these signals to always become the corresponding signals having the same storage period. In the specific example shown in FIG. 7, the difference between the signal output as the second output and the signal delayed by one horizontal reading period by the memory 44 is calculated by the differential circuit 46, thereby obtaining the operation signal of a certain level. In this regard, in the second horizontal reading period shown in FIG. 7, since the obtained signal Sig2b has a storage period of about one horizontal reading period as described above, the memory control means 45 resets the signal of the previous one horizontal reading period stored in the memory 44 to all zeros based on the control of the control means 42. Thus, the differential circuit 46 directly outputs the signal Sig2b as the operation signal.

The operation signal output from the differential circuit 46 is input into the image-pickup control portion 47 to be used for image-pickup control such as AF control, AE control, etc. The control of the charge storage time, etc., of the image pickup device 1 is performed based on the result calculated by the image-pickup control portion 47.

The control operation by the control means 42 in the image pickup apparatus 41 having such a configuration is performed, for example, as follows.

First, the control means 42 controls the first selection means 7 of the first reading means 5 to read the signals of all the pixels of the pixel portion 3 as the first output.

The control means 42 performs the estimation of a shooting scene based on the signals of all the pixels of the pixel portion 3 read as the first output from the first reading means 5. The control means 42 determines the sub-areas necessary to perform image-pickup control such as AF, AE, etc., based on a predetermined standard in accordance with the estimated shooting scene.

The control means 42 controls the second selection means 8 of the second reading means 6 so as to read the signals of the pixels included in the determined sub-areas. Thus, it becomes possible for the second reading means 6 to read the signals of the areas necessary for image-pickup control a plurality of times in a vertical reading period. In this regard, the delay time, etc., in the memory 44 differs depending on the size and the shape of the sub-areas which has been set, and thus the memory control means 45 controls the delay time, etc., by the memory 44 based on the information of the sub-areas set by the control means 42.

Thus, using the operation signal that has been read from the second reading means 6 at a high speed and processed by the differential circuit 46, the image-pickup control portion 47 performs image-pickup control such as AE, AF, etc., at a high speed.

The control means 42 performs the determination of a shooting scene using the signals of all the pixels of the pixel portion 3 described above, for example, at a predetermined cycle. When a shooting scene is determined to have changed, the above-described sub-areas are changed dynamically. Thus, it is possible to always perform the most appropriate image-pickup control dynamically corresponding to the state of the shooting object.

According to the third embodiment described above, substantially the same effect as that of the first and the second embodiments described above is obtained. At the same time, the sub-areas necessary for performing image-pickup control, etc., are automatically set in accordance with a shooting scene, etc., and thus it is possible to perform the most appropriate image-pickup control dynamically and at a high speed.

### Fourth Embodiment

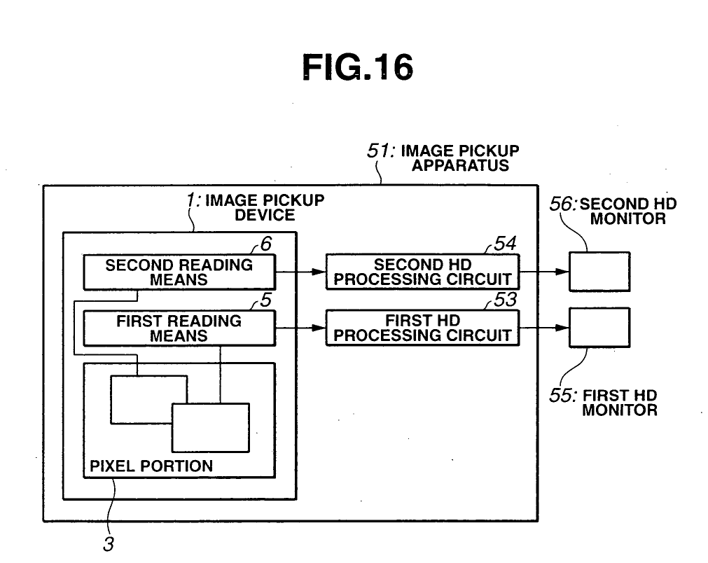

FIG. 16 shows a fourth embodiment of the present invention, and is a block diagram illustrating an example of the configuration of the image pickup system in which monitors are connected to an image pickup apparatus.

In the fourth embodiment, the same parts as those of the first to the third embodiments described above are marked with the same reference symbols, and the descriptions thereof are omitted. A description will be mainly given only of the different parts.

This image pickup system has a configuration in which a first HD monitor 55 and a second HD monitor 56 are connected to an image pickup apparatus 51.

The image pickup device 1 provided in the image pickup apparatus 51 includes a pixel portion 3, a first reading means 5 for reading signals of sub-areas of the pixel portion 3, the second reading means 6 for reading the signals of the other sub-areas from the pixel portion 3. Here, the sub-areas read by the first reading means 5 and the sub-areas read by the second reading means 6 may partly overlap with each other.

More specifically, for example, the pixel portion 3 has a configuration including 8-million pixels, and the sub-areas to be read by the first reading means 5 and the second reading means 6 have a configuration includes 2-million pixels for producing high-definition (HD) output. The sub-areas to be HD output can be set independently by the first reading means 5 and the second reading means 6, respectively at any positions from all the pixels in the pixel portion 3. In this regard, although not shown in FIG. 16, control means as shown in FIG. 14 is similarly provided in the image pickup apparatus 51, and thus the first reading means 5 and the second reading means 6 are controlled to set and change the sub-areas.

The HD output read from the first reading means 5 is input into the first HD processing circuit 53 provided in the image pickup apparatus 51, in which image processing, etc., is performed in real time.

Similarly, the HD output read from the second reading means 6 is input into the second HD processing circuit 54 provided in the image pickup apparatus 51, in which image processing, etc., is performed in real time.

The HD signal processed by the first HD processing circuit 53 is displayed in real time onto the first HD monitor 55 connected to the image pickup apparatus 51. Also, the HD signal processed by the second HD processing circuit 54 is displayed in real time onto the second HD monitor 56 connected to the image pickup apparatus 51.

In this regard, in the above description, two reading means are provided to extract and display two sub-areas. However, the reading means is not limited to this as a matter of course. It is possible to have a configuration in which any number of sub-areas are extracted and displayed. Also, the size and the shape of the sub-area can be arbitrarily set for each reading means.

According to the fourth embodiment described above, the same effect as that of the first to the third embodiments described above is obtained. At the same time, it becomes possible to independently extract, process, and display the video images of the sub-areas of a desired size and a desired position from the image pickup device including many pixels in real time.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. An image pickup device comprising:
a pixel portion including a plurality of pixels arranged in a two-dimensional array for generating and storing photoelectric conversion signals in accordance with an amount of light exposure;
a plurality of reading means for allowing to read each of the photoelectric conversion signals stored in the pixels of the pixel portion at a predetermined cycle; and
a plurality of selection means provided corresponding to the plurality of reading means with one-to-one relation for selecting a pixel to be read by the reading means from all the pixels arranged in the pixel portion,
wherein at least one of the plurality of reading means reads a photoelectric conversion signal stored in the pixel selected by the corresponding selection means a plurality of times in the predetermined cycle.

2. An image pickup device comprising:
a pixel portion including a plurality of pixels arranged in a two-dimensional array for generating and storing photoelectric conversion signals in accordance with an amount of light exposure;
a plurality of reading means for reading each of the photoelectric conversion signals stored in the pixels of the pixel portion;
a plurality of selection means provided corresponding to the plurality of reading means with one-to-one relation for selecting a pixel to be read by the reading means from all the pixels arranged in the pixel portion; and
memory means for individually storing the photoelectric conversion signal read from the pixel arranged in the pixel portion corresponding to each of the plurality of reading means.

3. The image pickup device according to claim 2,
wherein the memory means includes a capacitor.

4. An image pickup apparatus comprising:
an image pickup device including a pixel portion including a plurality of pixels arranged in a two-dimensional array for generating and storing photoelectric conversion signals in accordance with an amount of light exposure, a plurality of reading means for allowing to read each of the photoelectric conversion signals stored in the pixels of the pixel portion at a predetermined cycle, and a plurality of selection means provided corresponding to the plurality of reading means with one-to-one relation for selecting a pixel to be read by the reading means from all the pixels arranged in the pixel portion, wherein at least one of the plurality of reading means reads a photoelectric conversion signal stored in the pixel selected by the corresponding selection means a plurality of times in the predetermined cycle; and
control means for individually controlling a pair of the reading means included in the image pickup device and the selection means corresponding to the reading means for each of the pairs.

5. An image pickup apparatus comprising:
an image pickup device including a pixel portion including a plurality of pixels arranged in a two-dimensional array for generating and storing photoelectric conversion signals in accordance with an amount of light exposure; a plurality of reading means for reading each of the photoelectric conversion signals stored in the pixels of the pixel portion, a plurality of selection means provided corresponding to the plurality of reading means with one-to-one relation for selecting a pixel to be read by the reading means from all the pixels arranged in the pixel portion, and memory means for individually storing the photoelectric conversion signal read from the pixel arranged in the pixel portion corresponding to each of the plurality of reading means; and
control means for individually controlling a pair of the reading means included in the image pickup device and the selection means corresponding to the reading means for each of the pairs.
